(19) United States
(12) Patent Application Publication
(10) Pub. No.: US 2026/0149167 A1
(43) Pub. Date: May 28, 2026

(54) Integrated Antenna Radiating Configuration with Magnetic Lid Latching Mechanism

(71) Applicant: Dell Products L.P., Round Rock, TX (US)

(72) Inventors: Wei-Yu Lai, Da'an District (TW); Shang-Chu Chien, Taoyuan City (TW)

(21) Appl. No.: 18/963,586

(22) Filed: Nov. 28, 2024

(51) Int. Cl. H01Q 1/22; H01Q 9/30; H01Q 19/10; H01Q 19/30

(52) U.S. Cl. CPC H01Q 1/2266; H01Q 9/30; H01Q 19/10; H01Q 19/30

(57) ABSTRACT

Described herein are integrated cables and magnets operating as radiating antenna in a notebook or laptop computer, a magnet in the base of the laptop computer provides a latching force with a magnet in the antenna. In conventional laptop mode, the antenna functions as a monopole. In tablet mode and closed mode, the magnets can be sized, and placed to provide directional control.

### BACKGROUND OF THE INVENTION

### Field of the Invention

The present invention relates to information handling systems. More specifically, embodiments of the invention provide for a laptop/notebook computer with integrated latching magnets and radiating antennae.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems include laptop/notebook computer systems. Such laptop/notebook computer systems (i.e., laptop) can make use of magnets as lid latching components to secure the laptop when closed. Laptops further implement antennas to provide for wireless communications. Antenna design and placement in a laptop takes into consideration the size of the antenna and placement near magnets. Because an antenna/antennae can be bulky, are metallic, and have metallic characteristics, design and placement takes into consideration proximity to magnets. This is to avoid or minimize impact to the radiating/transmission ability of antenna/antennae. Therefore, laptop latching magnets and radiating antennae are separated and kept a certain distance to avoid antennae transmission interference.

### SUMMARY OF THE INVENTION

A laptop computer comprising a base side that comprises magnet; a top side that comprises an antenna, wherein the antenna comprises: cables, foils, and an integrated magnet operating as a radiating antenna for wireless communication of the laptop computer, wherein the magnet of the base and the integrated antenna provide a latching force when the laptop is closed or when the laptop is in tablet mode.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a general illustration of components of an information handling system as implemented in the present invention;

FIG. 2 is a laptop/notebook computer as implemented in the present invention;

FIG. 3 is a laptop/notebook computer with an integrated latching magnets and radiating antenna as implemented in the present invention;

FIG. 4 is an implementation of an antenna in the top cover of a laptop as implemented in the present invention;

FIG. 5 is an implementation of an antenna in the top cover of a laptop with foil;

FIG. 6 is a monopole antenna used in conventional laptop mode;

FIG. 7 is a monopole antenna used in tablet mode;

FIG. 8 is an implementation to address specific absorption rate (SAR); and

FIG. 9 is beam control based on location of magnet relative to one another.

### DETAILED DESCRIPTION

Various implementations provide for integration of latching magnets to secure a laptop computer with a radiating antenna that provides wireless communication for the laptop computer. The magnets and antenna are designed and placed to provide optimal radiation for antenna. Implementations provide for different configuration usage of the laptop computer, such as conventional laptop use with a display screen or panel and a keyboard or base, and a configuration where the laptop functions as a tablet.

Implementations consider wavelength of antenna operating frequency as to design guidance regarding size of magnet(s), where the antenna and magnet(s) are integrated to provide a magnet antenna compared traditional printed circuit board (PCB) antennas.

Further implementations provide for beam antenna implementing Yagi concepts to use director and reflector applications through mutual relationship size and location between two magnets of the integrated magnet antenna to efficiently control radiation direction. This can improve specific absorption rate (SAR) that a user is exposed to by the radio frequency (RF) electromagnetic field of the integrated magnet antenna.

Implementations can further provide for utilization of the two magnets to be placed in locations between the antenna and reflector or director to provide antenna performance in closed and tablet mode.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

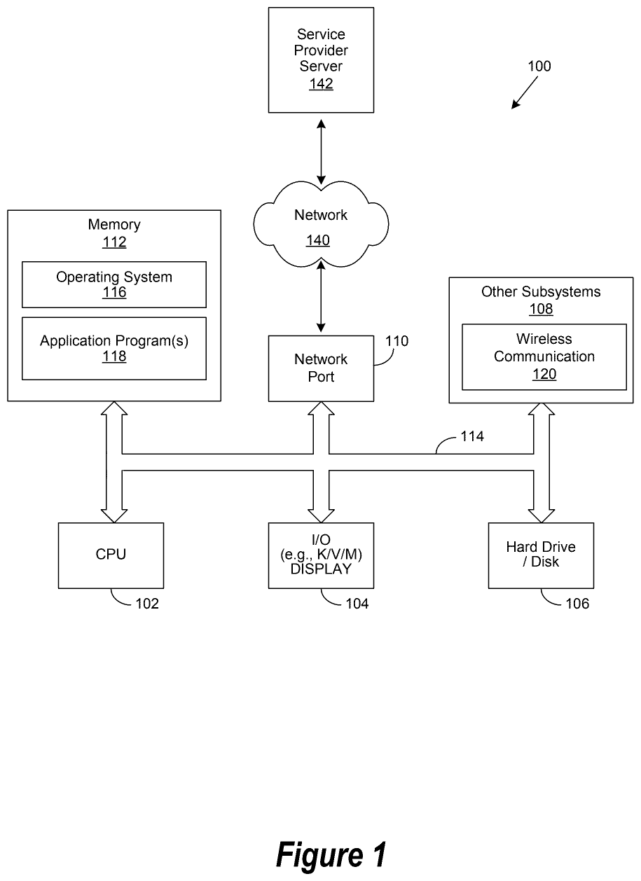

FIG. 1 is a generalized illustration of an information handling system 100 that can be used to implement the system and method of the present invention. The information handing system 100 can be a host to the peripheral devices described herein. The information handling system 100 can include desktop computer, server computer, a laptop or notebook personal computer (PC), a tablet computer, PC integrated into a keyboard, etc. In particular, implementations described herein provide for a laptop or notebook PC system or tablet computer.

The information handling system 100 includes a processor (e.g., central processor unit or “CPU”) 102, input/output (I/O) devices 104, such as a microphone, a keyboard, a video/display, a mouse, and associated controllers (e.g., K/V/M), a hard drive or disk storage 106, and various other subsystems 108. In particular, I/O devices 104 include a display as further described herein. As further described herein the display, embodiments of the display provide for specific components as implemented in the present invention.

In various embodiments, the information handling system 100 also includes network port 110 operable to connect to a network 140, where network 140 can include one or more wired and wireless networks, including the Internet. Network 140 is likewise accessible by a service provider server 142. The information handling system 100 likewise includes system memory 112, which is interconnected to the foregoing via one or more busses 114.

System memory 112 can be implemented as hardware, firmware, software, or a combination of such. System memory 112 further includes an operating system (OS) 116. Embodiments further provide for the system memory 112 to include software applications 118. In various implementations, other subsystems 108 can include wireless communication 120 that supports wireless communication for the information handling system 100.

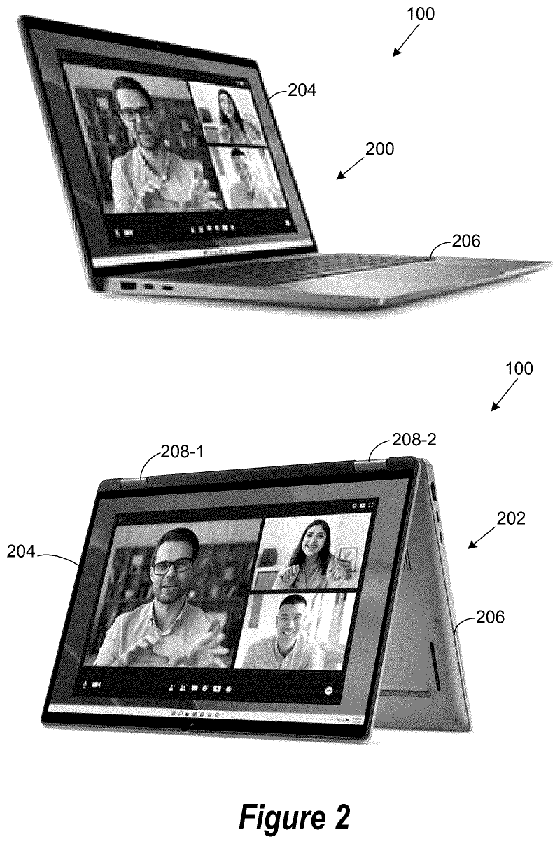

FIG. 2 illustrates a laptop/notebook computer (i.e., laptop) 100 as implemented in the present invention. The laptop 100 is configured as an information handling system (HIS) 100 as described in FIG. 1. The laptop 100 can be implemented as a conventional laptop as shown by view 200, or implemented as a tablet as shown in view 202. The laptop 100 includes a top cover 204 and a base 200. The laptop 100 also includes hinges 208, as represented by hinges 208-1 and 208-2.

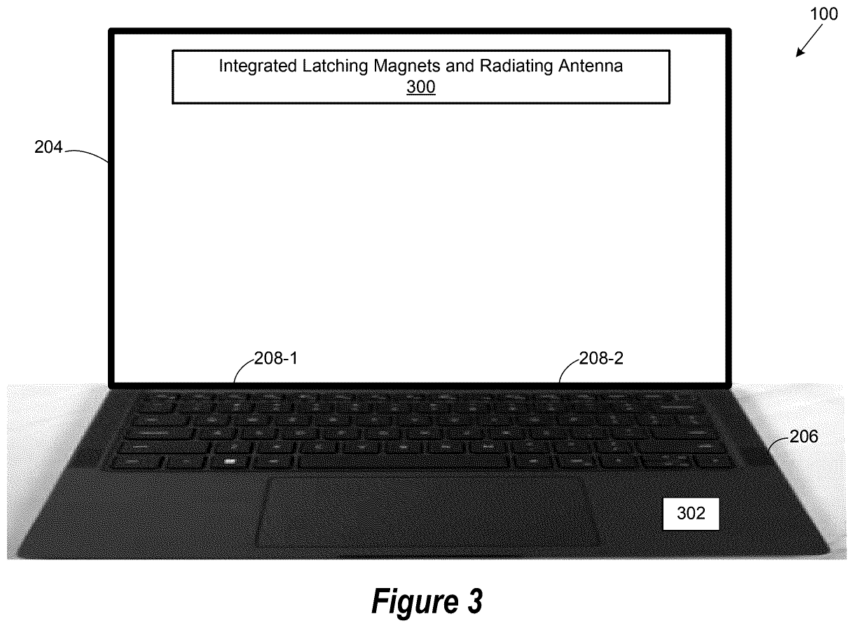

FIG. 3 is a laptop/notebook computer (i.e., laptop) 100 with an integrated latching magnets and radiating antenna 300 as implemented in the present invention. Implementations provide for the laptop 100 to include the integrated latching magnets and radiating antenna 300 on the top cover 204 of the laptop 100. When the laptop 100 is closed, magnetic attraction is provided between a magnet in the integrated latching magnets and radiating antenna 300 and a magnet 302 in the base 206 of the laptop 100. In tablet configuration (i.e., top cover 204 flipped over opposite of the base 206, the magnet in the integrated latching magnets and radiating antenna 300 and magnet secures the laptop 100.

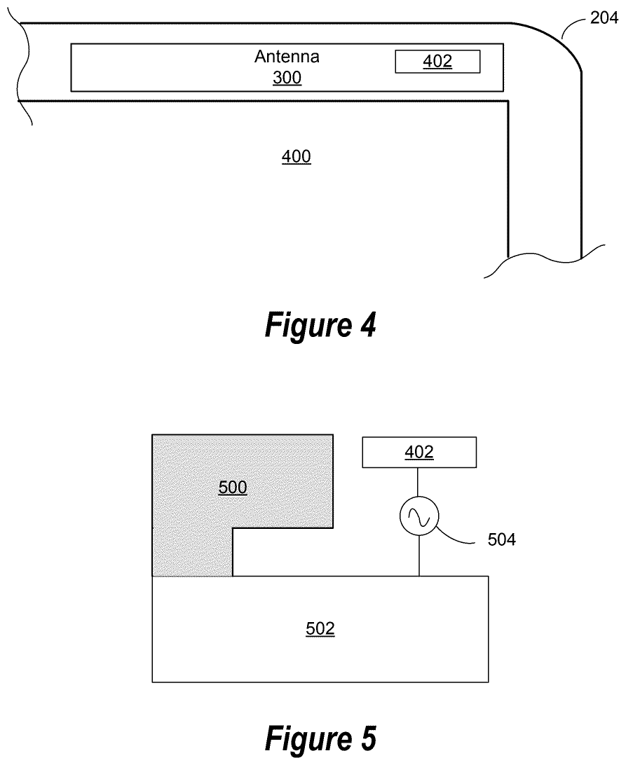

FIG. 4 illustrates an implementation of an antenna 300 in the top cover 204 of laptop 100. Design consideration takes into account space available in the laptop 100 to provide an antenna 300 (integrated latching magnets and radiating antenna 300). Requirements may be such to provide various antennas. For example, 5G radio may require 4 LTE+2 Wi Fi antennas. To account for limited space on the top cover 204, certain prior implementations place antennas on a base 206; however, this can lead to noise interference and structural blockage of signals.

In the implementation shown in FIG. 4, the antenna 300 is placed on the edge or corner of the top cover 204 near the panel 400 of the laptop 100. A magnet 402 is part of the antenna 300, acting as a radiator. Implementations are provided for a metal coating (not shown) to cover the magnet 402. The metal coating is designed to be part of the antenna 300, as to size, location and signal feeding. element if it is designed with the correct size and location for signal feeding. The metal characteristic of the magnet 402 is further considered in integration into of the antenna 300.

FIG. 5 illustrates a Copper (Cu)/Aluminum (Al) foil is added as auxiliary material to provide for low band enhancement of the antenna 300. In particular to extend as a parasitic component. The foil 500 (e.g., copper foil) is added as a parasitic coupling element to fine tune the monopole antenna 300. Implementations provide for an antenna feed 504 between the magnet 402 and ground 502.

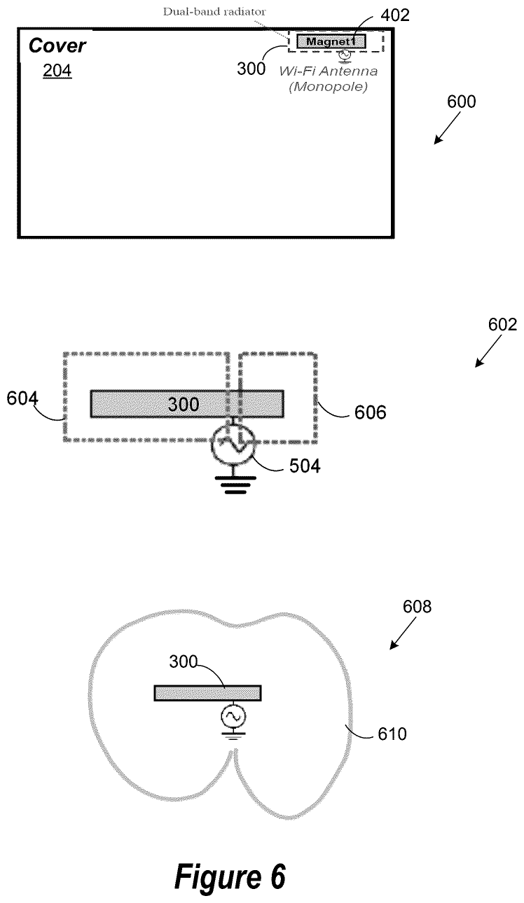

FIG. 6 illustrates a monopole antenna as used in conventional laptop mode. In top cover 204 operating in conventional laptop mode as shown by view 600, the antenna 300 acts as monopole antenna, providing wireless communication (e.g., Wi-Fi antenna). Therefore, in laptop mode, the antenna 300 radiates as a simple monopole. The magnet 402 acts a dual-band radiator of the antenna 300.

View 600 shows varying lengths/sections of the antenna 300 to support different bands. The antenna 300 includes cables mounted with the magnet 402 to form a Wi-Fi dual-band monopole antenna. The lengths of the cables are designed to support quarter wavelength and half-wavelength resonance. Length 604 supports 2.4 GHz band low band resonance and length 606 supports 5-6 GHz high band resonance.

View 608 shows the radiation pattern of antenna 300. The Wi-Fi dual-band monopole antenna 300 provides a quasi omni-directional radiation pattern 610 that enables signal transmission and reception for all spatial directions.

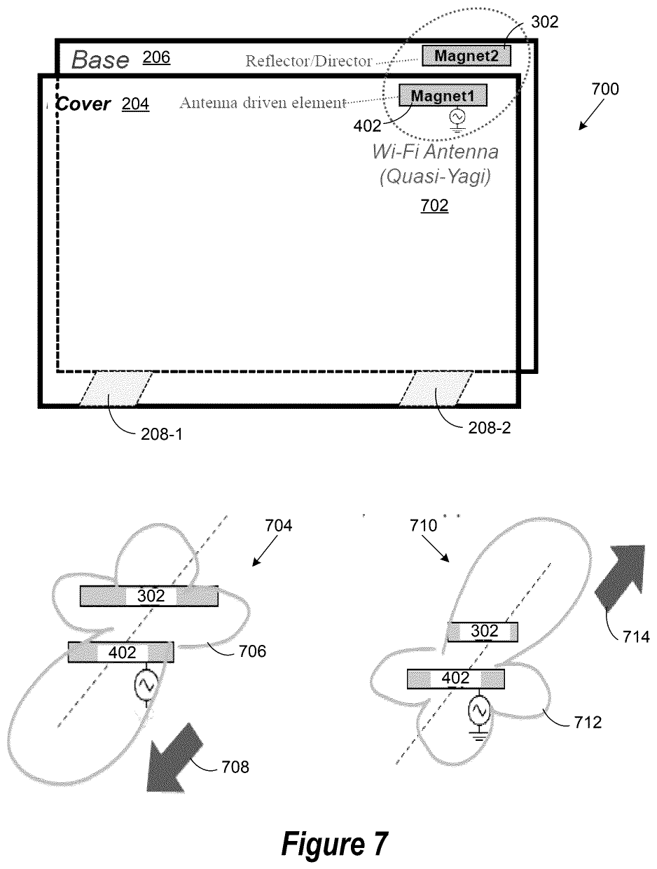

FIG. 7 illustrates a monopole antenna as used in tablet mode. As shown in 700, the magnet 302 and the magnet 402 are attracted to one another to provide a latching force to secure top cover 204 and base 206 in tablet mode. This latching force is also used in securing the laptop 100 when it is closed.

In certain implementations, the antenna 300 acts as a quasi-Yagi, or beam directional, Wi-Fi antenna 702. Particular implementations of the quasi-Yagi antenna can be based on laptop 100 platform design requirements. For example, there can be two types of quasi-Yagi antenna.

For one implementation, as shown in 704, there is a driven element plus a reflector. The magnet 302 acts a reflecting element, and is designed to be longer than the magnet 402. The radiation pattern is shown as 706. The main beam 708 of the radiation pattern 706 will radiate outward from the top cover 204 side.

For another implementation, as shown in 710, there is a driven element plus a director. The magnet 302 acts a directing element, and is designed to be shorter than the magnet 402. The radiating antenna pattern is shown as 712. The main beam 714 of the radiating antenna pattern 712 will radiate outward from the base 206 side.

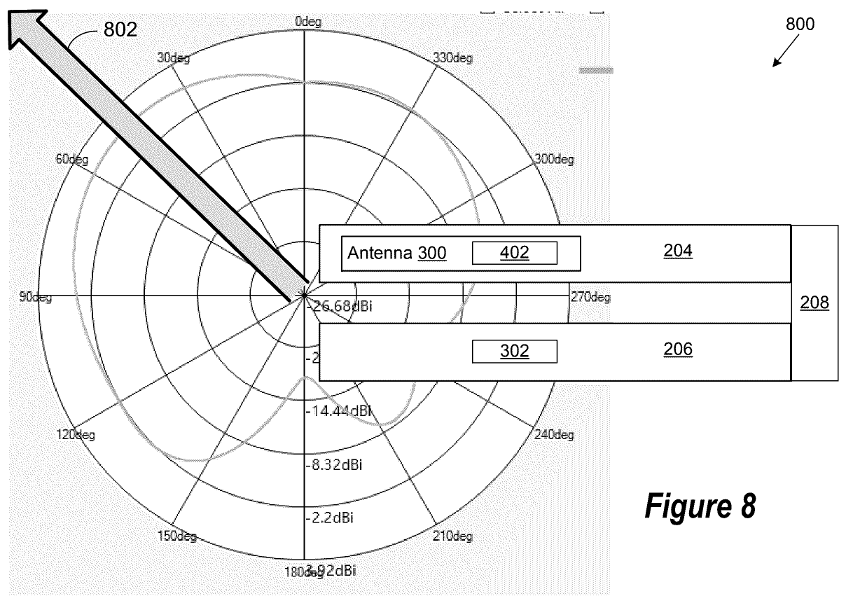

FIG. 8 shows an implementation to address specific absorption rate (SAR). It is desirable to minimize radiation exposure to a user. SAR is a measure of the rate of RF (radiofrequency) energy absorption by the body from the source being measured. In certain instances, particular guidelines may be implemented to limit SAR. It may be desirable to limit the maximum output signal strength of the radiation beam of the antenna 300 that is emitted to a user.

View 800 shows a configuration that addresses the SAR concern. The magnet 302 located in base 206 acts as a reflecting element, reflecting the beam as shown by signal beam 802. The signal beam 802 can be controlled to radiate toward another direction. Output power of the antenna 300 can be increased to provide better signal quality, since RF exposure to a user is mitigated. As discussed above, the magnet 302 can be designed as a reflector or director, based on relative length to the magnet 402. This allows toggling of beam direction based on laptop 100 platform requirements.

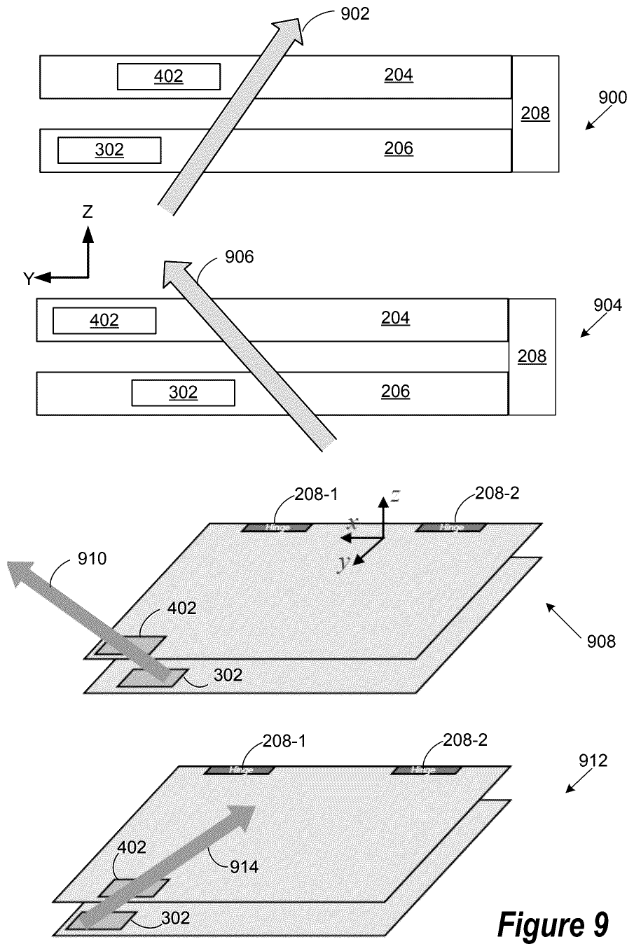

FIG. 9 shows beam control based on location of magnet relative to one another. Beam direction can be manipulated by relative location between the magnet 302 and magnet 402. Locations of magnets 302 and 402, and beam direction can further address SAR issues. In particular, bottom SAR and edge SAR exposure.

In side view 900, magnet 402 is placed in relative location to magnet 302 to generate a beam direction 902. In side view 904, magnet 402 is placed in relative location to magnet 302 to generate a beam direction 906. In isometric view 908, magnet 402 is placed in relative location to magnet 302 to generate a beam direction 910. In isometric view 912, magnet 402 is placed in relative location to magnet 302 to generate a beam direction 914.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A laptop computer comprising:
a base that comprises magnet;
a top cover that comprises an antenna, wherein the antenna comprises:
cables, foils and an integrated magnet operating as a radiating antenna for wireless communication of the laptop computer, wherein the magnet of the base and the integrated antenna provide a latching force when the laptop is closed or when the laptop is in tablet mode.

2. The laptop of claim 1, wherein the antenna is a monopole antenna when the laptop is in conventional laptop mode.

3. The laptop of claim 2, wherein the monopole antenna provides quasi-omni directional radiation patter enabling signal transmission and reception in spatial directions.

4. The laptop of claim 1, wherein the magnet of the base acts a radiator for the antenna.

5. The laptop of the claim 1, wherein the antenna further comprises a metal coating.

6. The laptop of the claim 1, wherein the antenna further comprises a metal foil that acts as parasitic element to fine tune the antenna.

7. The laptop of the claim 1, wherein the cables are of varying length support quarter wavelength and half wavelength resonance.

8. The laptop of the claim 1, wherein the antenna is a quasi-Yagi beam directional antenna.

9. The laptop computer of claim 8, wherein one type of quasi-Yagi beam directional antenna provides for the magnet of the base act as reflecting element and is longer than the integrated magnet.

10. The laptop computer of claim 8, wherein one type of quasi-Yagi beam directional antenna provides for the magnet of the base act as directing element and is shorter than the integrated magnet.

11. The laptop computer of claim 1, wherein the magnet of the base acts as a reflecting unit to direct beam of the antenna away from the base.

12. The laptop computer of claim 1, wherein the magnet of the base and integrated magnet are place in relative locations to provide beam direction of the antenna.

13. An antenna of a laptop computer comprising:
cables and an integrated magnet operating as a radiating antenna for wireless communication of the laptop computer, wherein a magnet of a base of the laptop computer and the integrated antenna provide a latching force when the laptop is closed or when the laptop is in tablet mode.

14. The antenna of claim 13, wherein the antenna is a monopole antenna when the laptop is in conventional laptop mode.

15. The antenna of claim 13, wherein the magnet of the base acts a radiator for the antenna.

16. The antenna of claim 13, wherein the antenna further comprises a metal coating.

17. The antenna of claim 13, wherein the antenna further comprises a metal foil that acts as a parasitic element to fine tune the antenna.

18. The antenna of claim 13, wherein the cables are of varying length and support quarter wavelength and half wavelength resonance.

19. The antenna of claim 13, wherein the antenna is a quasi-Yagi beam directional antenna.

20. The antenna of claim 13, wherein the magnet of the base and integrated magnet are place in relative locations to provide beam direction of the antenna.
